(19) United States
(12) Patent Application Publication
(10) Pub. No.: US 2025/0226134 A1
(43) Pub. Date: Jul. 10, 2025

(54) BOBBIN STRUCTURE, MAGNETIC ELEMENT AND METHOD FOR LEADING OUT COIL

(71) Applicant: Delta Electronics (Shanghai) CO., LTD., Shanghai (CN)

(72) Inventors: Lin LI, Shanghai (CN); Yanwei HU, Shanghai (CN); Xueyong ZHAI, Shanghai (CN); HSIEH-SHEN HSIEH, Shanghai (CN)

(73) Assignee: Delta Electronics (Shanghai) CO., LTD., Shanghai (CN)

(21) Appl. No.: 18/963,598

(22) Filed: Nov. 28, 2024

(30) Foreign Application Priority Data
Jan. 4, 2024 (CN) 202410016810X

(51) Int. Cl. H01F 5/02; H01F 5/04; H01F 5/06; H01F 41/082

(52) U.S. Cl. CPC H01F 5/02; H01F 5/04; H01F 5/06; H01F 41/082

(57) ABSTRACT

A bobbin structure, a magnetic element and a method for leading out a coil are provided. The bobbin structure includes a main body, a guide part and lead-out sleeve. The main body is used for winding a coil; the guide part is disposed at an end portion of the main body in a vertical direction, where, a guide channel is provided in the guide part; the lead-out sleeve is disposed on the guide part and configured to communicate with the guide channel, the lead-out sleeve includes an accommodating structure with an opening, and the accommodating structure is configured to protrude from the guide part; the guide channel is used to guide a coil end into the accommodating structure, the accommodating structure is malleable and configured to be able to close the opening after being pressed to form a closed annular space for wrapping the coil end.

### CROSS REFERENCE

This application claims priority to Chinese Patent Application No. 202410016810X, titled “Bobbin Structure, Magnetic Element and Method for Leading Out Coil”, filed on Jan. 4, 2024, the entire contents thereof are incorporated herein by reference.

### TECHNICAL FIELD

The present disclosure generally relates to the technical field of magnetic devices, and in particular, to a bobbin structure, a magnetic element and a method for leading out a coil.

### BACKGROUND

When a magnetic element works in a system, it is necessary to connect the lead-out end of the coil windings to the system end to realize its electrical performance. For the high-power magnetic element that need to be soldered on a PCB (Printed Circuit Board), the common connection method at present is the through-hole welding. That is, insert the pin of the magnetic element into the through hole of the PCB, and then fix the pin in the through hole by welding.

For the high-power magnetic element, considering the skin effect, its coil usually formed by multi-stranded wires. However, it is necessary to occupy a large space when the ends of the multi-stranded wires are connected with the pins, and the operation is complicated, and it is difficult to realize automatic wire arrangement.

### SUMMARY

According to exemplary embodiments of the present disclosure, a bobbin structure is provided, the bobbin structure including: a main body, used for winding a coil; a guide part, disposed at an end portion of the main body in a vertical direction, wherein a guide channel is provided in the guide part; and a lead-out sleeve, disposed on the guide part and configured to communicate with the guide channel, the lead-out sleeve including an accommodating structure with an opening, and the accommodating structure configured to protrude from the guide part; where, the guide channel is used to guide a coil end into the accommodating structure, the accommodating structure is malleable and configured to be able to close the opening after being pressed to form a closed annular space for wrapping the coil end.

According to exemplary embodiments of the present disclosure, a magnetic element is provided, the magnetic including a bobbin structure, which including a main body, a guide part and a lead-out sleeve; where, the guide part is disposed at an end portion of the main body in a vertical direction, a guide channel is provided in the guide part; the lead-out sleeve is disposed on the guide part and configured to communicate with the guide channel, the lead-out sleeve includes an accommodating structure with an opening, and the accommodating structure is configured to protrude from the guide part; a coil, wound on the main body, and a coil end is guided by the guide channel and located in the lead-out sleeve, the lead-out sleeve is provided with a closed annular space, and the coil end is fixedly connected in the closed annular space.

According to exemplary embodiments of the present disclosure, a method for leading out a coil is provided, the method including: providing a bobbin structure described in any one of the above embodiments, the bobbin structure including a main body, a guide part and a lead-out sleeve; where, the guide part is disposed at an end portion of the main body in a vertical direction, a guide channel is provided in the guide part; the lead-out sleeve is disposed on the guide part and configured to communicate with the guide channel, the lead-out sleeve includes an accommodating structure with an opening, and the accommodating structure is configured to protrude from the guide part; winding a coil around the main body of the bobbin structure, and guiding a coil end of the coil into the lead-out sleeve through the guide channel of the guide part of the bobbin structure; pressing the lead-out sleeve to form a closed annular space to wrap the coil end; welding the coil end to the lead-out sleeve to form a lead-out end.

### BRIEF DESCRIPTION OF THE DRAWINGS

The above and other features and advantages of the present disclosure will become more apparent by describing in detail exemplary embodiments thereof with reference to the accompanying drawings.

FIG. 1 is a perspective schematic view of a bobbin structure of some embodiments of the present disclosure.

FIG. 2 is a perspective schematic view of the bobbin structure of some embodiments of the present disclosure.

FIG. 3 is a perspective schematic view of the bobbin structure wound with a coil of some embodiments of the present disclosure, where, the lead-out sleeve is not pressed.

FIG. 4 is a perspective schematic view of the bobbin structure wound with a coil of some embodiments of the present disclosure, where, the lead-out sleeve has been pressed.

FIG. 5 is a perspective schematic view of the lead-out sleeve of some embodiments of the present disclosure.

FIG. 6 is a perspective schematic view of the lead-out sleeve which is pressed to form a closed annular space of some embodiments of the present disclosure.

FIG. 7 is a perspective schematic view of the lead-out sleeve of some embodiments of the present disclosure.

FIG. 8 is a perspective schematic view of the main body and the guide part of some embodiments of the present disclosure.

FIG. 9 is an enlarged view at A in FIG. 8.

FIG. 10 is a perspective schematic view of a bobbin structure of some embodiments of the present disclosure.

FIG. 11 is an enlarged view at B in FIG. 10.

FIG. 12 is a perspective schematic view of the magnetic element of some embodiments of the present disclosure, where, the lead-out sleeve is not pressed.

FIG. 13 is a perspective schematic view of the magnetic element of some embodiments of the present disclosure, where, the lead-out sleeve is in a state of being pressed.

### DETAILED DESCRIPTION

Exemplary embodiments will now be described more fully with reference to the accompanying drawings. However, the exemplary embodiments can be implemented in various forms and should not be construed as limited to the embodiments set forth herein. Rather, these embodiments are provided so that the present disclosure will be thorough and complete, and will fully convey the concepts of the exemplary embodiments to those skilled in the art. The same reference numerals in the drawings indicate the same or similar structures, so their detailed description will be omitted.

The following description of different exemplary embodiments of the present disclosure is made with reference to the accompanying drawings, the accompanying drawings form a part of the present disclosure, and show different exemplary structures, systems, and steps that can implement multiple aspects of the present disclosure by way of example. It should be understood that other specific arrangements of components, structures, exemplary devices, systems and steps may be used, and structural and functional modifications may be made without departing from the scope of the present disclosure. Moreover, although the terms “above”, “between” and “within” may be used in this specification to describe different exemplary features and elements of the present disclosure, these terms are used herein only for convenience, for example, according to the directions of the examples in the drawings. Nothing in this specification should be understood as requiring a specific three-dimensional orientation of the structure to fall within the scope of this disclosure. In addition, the terms “first” and “second” are only used as marks, and are not numerical restrictions on their objects.

The flow charts shown in the attached drawings are only illustrative, and do not necessarily include all contents and operations/steps, nor do they have to be executed in the described order. For example, some operations/steps can be decomposed, while others can be combined or partially combined, so the actual execution order may change according to the actual situation.

In addition, in the description of the present disclosure, “a plurality of/multiple” means at least two, such as two, three, etc., unless otherwise specifically defined.

High-power magnetic elements usually use multi-stranded wires as a coil, the ends of the coil are connected with the pins, and then the pins are inserted into the through holes of the PCB for welding to realize the electrical connection between the magnetic element and the circuit on the PCB.

In the related art, the connection between the end of the coil and the through hole can be realized in various ways. For example, one way is to wind the end of the coil around the pin, and then insert the pin into the through hole. However, in this way, the end of the coil will be messy, and the space for wire arrangement is narrow, so it is difficult to realize automatic wire arrangement and to operate, and it needs to occupy a large space. Another way is to use pins to wrap the end of the coil, but this requires changes to the pins, and the changed pins occupy more space and lead to wire waste. Another way is to directly connect the multi-stranded wires at the end of the coil with the through holes, in this way, although the pins are omitted, the multi-stranded wires are easy to be scattered, and it is not easy to be fixed in the through hole, so it is necessary to twist the wires manually, and the automatic wire arrangement cannot be realized, and the reserved wire ends are too long to cause waste.

In the embodiments of the present disclosure, a bobbin structure 100 is provided, which can reduce the occupied space and is simple to operate, and can realize automatic wire arrangement and avoid wasting wires.

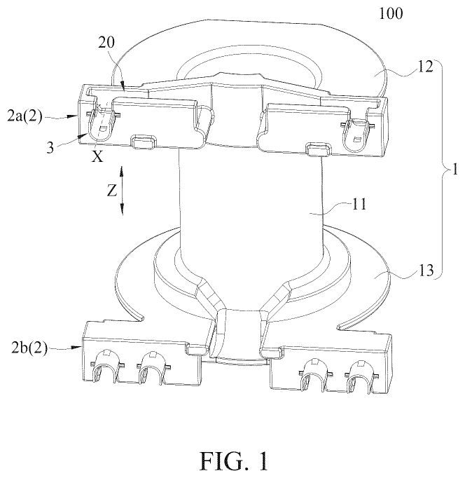

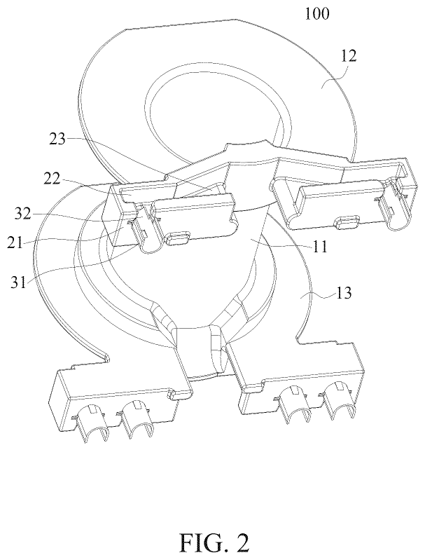

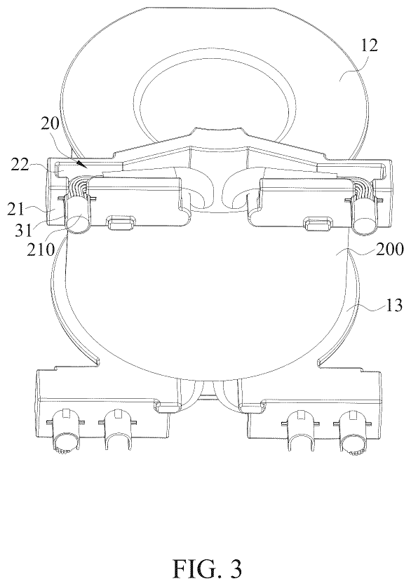

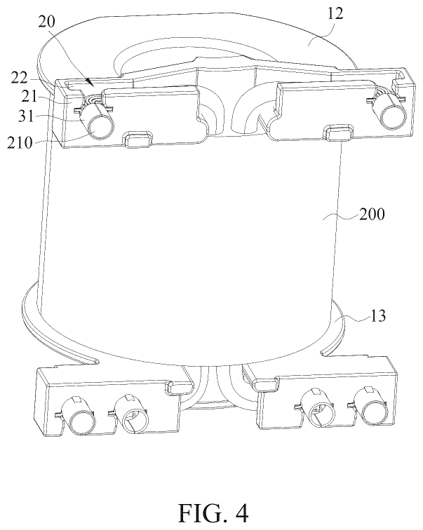

As shown in FIG. 1 and FIG. 2, a bobbin structure 100 of the embodiments of the present disclosure includes a main body 1, a guide part 2 and a lead-out sleeve 3. As shown in FIG. 3 and FIG. 4, the main body 1 is used for winding the coil 200. The main body 1 can include a winding portion 11, and a first flange portion 12 and a second flange portion 13 at both ends of the winding portion 11 in the vertical direction Z, the first flange portion 12 and the second flange portion 13 are configured to extend from the two opposite ends of the winding portion 11 along a plane perpendicular to the vertical direction Z, so that a winding space is formed between the two flange portions of the main body 1, the coil 200 is wound on the winding portion 11 and located in the winding space.

It should be noted that the vertical direction Z in the embodiments of the present disclosure is defined as the height direction of the main body 1, alternatively, when the main body 1 is in a shape of column or cuboid, etc., the vertical direction Z refers to the axial direction of the main body 1. The plane along which the first flange portion 12 and the second flange portion 13 extend is parallel to the radial direction of the main body 1, technical terms such as “vertical direction” and “radial direction” are only for the convenience of describing the structure of the embodiments of the present disclosure, and have no limiting significance.

In some embodiments of the present disclosure, the first flange portion 12, the winding portion 11 and the second flange portion 13 are distributed in the vertical direction Z.

As shown in FIG. 1 and FIG. 2, the guide part 2 is disposed at the end portion of the main body 1 in the vertical direction Z. In some embodiments of the present disclosure, the guide part 2 is disposed on the first flange portion 12 and/or the second flange portion 13, and a guide channel 20 is provided in the guide part 2. The lead-out sleeve 3 is disposed on the guide part 2 and is configured to communicate with the guide channel 20. The lead-out sleeve 3 includes an accommodating structure 31 with an opening, and the accommodating structure 31 protrudes from the guide part 2. As shown in FIG. 3, the guide channel 20 is used to guide the coil end 210 into the accommodating structure 31, as shown in FIG. 4, the accommodating structure 31 is malleable and configured to be able to close the opening after being pressed to form a closed annular space S for wrapping the coil end 210.

In the embodiment of the present disclosure, the coil end 210 can be guided into the lead-out sleeve 3 through the guide channel 20, so that the automatic wire arrangement can be realized, that is, the wire arrangement can be performed by using a mechanical arm without manual wire arrangement, and the multi-stranded wires at the coil end 210 will not be scattered (in order to highlight that the multi-stranded wires of the coil end 210 are not scattered, FIGS. 3, 4, 11 and 12 do not show the shape of the multi-stranded wires at the coil end 210, but simply show the whole state of the coil end 210 after soldering). When the coil end 210 is placed in the accommodating structure 31, the accommodating structure 31 can be pressed to close to form a closed annular space S to wrap the coil end 210, so that the coil end 210 with multi-stranded wires is accommodated in the closed annular space S, and forms a pin with the accommodating structure 31, which can be directly connected with the through hole of the PCB, thus reducing the occupied space, being simple in operation and more accurate in connection with the through hole.

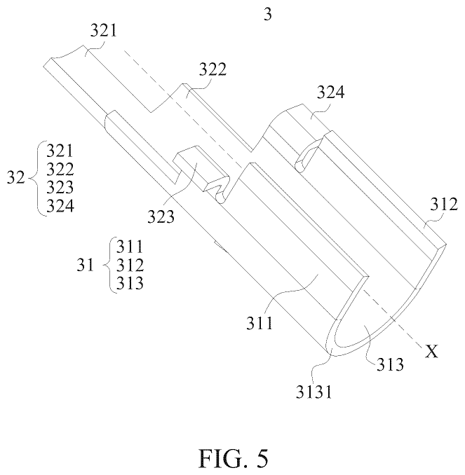

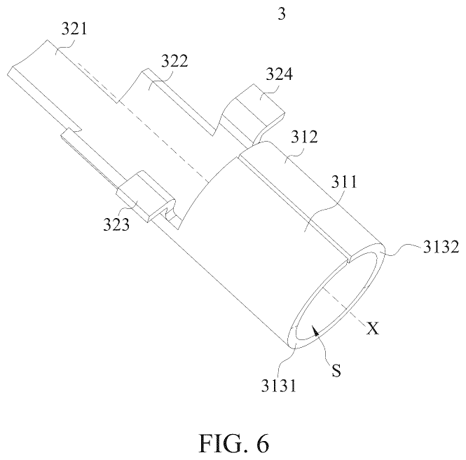

In some embodiments of the present disclosure, as shown in FIG. 5, the lead-out sleeve 3 includes a connecting structure 32, which is connected to the guide part 2. The accommodating structure 31 is connected with the connecting structure 32, and includes a first side wall 311, a second side wall 312 and an arc-shaped bottom wall 313. Where, the arc-shaped bottom wall 313 is connected with the connecting structure 32, and the first side wall 311 and the second side wall 312 are located at opposite sides of the arc-shaped bottom wall 313, so that the accommodating structure 31 is U-shaped. As shown in FIG. 6, the first side wall 311 and the second side wall 312 are configured to form a closed annular space S with the arc-shaped bottom wall 313 after being pressed.

As shown in FIG. 1 and FIG. 5, the lead-out sleeve 3 is configured to extend in the axial direction X, and the connecting structure 32 is connected with the guide part 2 in the axial direction X. Here, the axial direction X is the extending direction of the axis of the lead-out sleeve 3.

In some embodiments of the present disclosure, as shown in FIG. 5, the profile of the first section 3131 of the arc-shaped bottom wall 313 is semicircular, as shown in FIG. 6, the profile of the second section 3132 of the first side wall 311 and the second side wall 312 after being pressed is semicircular, so that the profile of the section of the accommodating structure 31 after being pressed is circular.

In the embodiment of the present disclosure, the first section 3131 and the second section 3132 are sections perpendicular to the axial direction X, respectively. That is, the arc-shaped bottom wall 313 is semicircular, and the first side wall 311 and the second side wall 312 form a semicircle matched with the arc-shaped bottom wall 313 after being pressed, therefore, the pressing process is easier, and the section of the accommodating structure 31 after being pressed is circular, so that the adaptability between the accommodating structure 31 and the through hole is improved, and the connection between the both is more stable. In addition, the radian of the arc-shaped bottom wall 313 of the accommodating structure 31 and the dimensions of the first side wall 311 and the second side wall 312 can also be designed according to the diameter of the through hole, so as to improve the adaptability.

Continuing with reference to FIG. 5, in the embodiment of the present disclosure, the connecting structure 32 includes an insertion portion 321, a positioning portion 322, a first positioning fin 323 and a second positioning fin 324. Where, the positioning portion 322 and the insertion portion 321 are connected in the axial direction X, and the positioning portion 322 and the insertion portion 321 are used for connecting with the guide part 2. The positioning portion 322 and the insertion portion 321 can be arc-shaped plate structures, one end of the positioning portion 322 in the axial direction X is connected with the insertion portion 321, and the other end is connected with the arc-shaped bottom wall 313 of the accommodating structure 31. In some embodiments, the axes of the insertion portion 321, the positioning portion 322 and the arc-shaped bottom wall 313 are the same. The first positioning fin 323 and the second positioning fin 324 are located at two opposite sides of the positioning portion 322 and bent away from the positioning portion 322.

As shown in FIG. 1 and FIG. 2, the guide part 2 can be provided at the flange portion of the main body 1. The guide part 2 includes a guide bottom wall 23, a first guide side wall 21 and a second guide side wall 22. The first guide side wall 21 and the second guide side wall 22 are located at opposite sides of the guide bottom wall 23 and connected with the guide bottom wall 23 to form the guide channel 20.

As shown in FIG. 1, the guide channel 20 communicates with the winding space at the main body 1, so that the coil end 210 can enter the guide channel 20 after being wound around the winding portion 11.

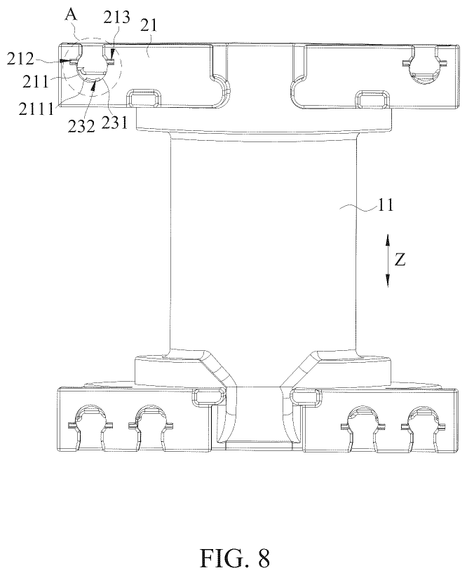

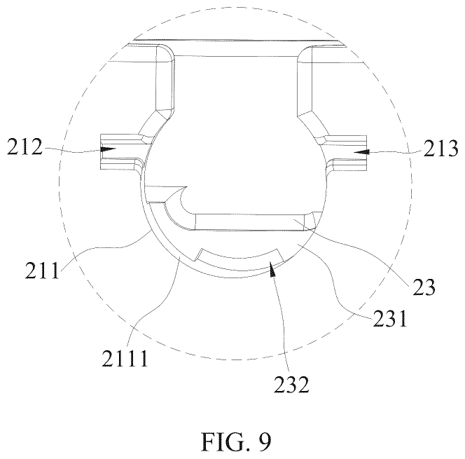

As shown in FIG. 8 and FIG. 9, the first guide side wall 21 is provided with a mounting groove 211 in the vertical direction Z. The mounting bottom surface 2111 of the mounting groove 211 is lower than the surface of the guide bottom wall 23 for carrying the coil end 210, so that a first side surface 231 of the guide bottom wall 23 facing the mounting groove 211 is exposed. The first side surface 231 is provided with an insertion opening 232 extending in a direction close to the second guide side wall 22. The insertion portion 321 of the connecting structure 32 is inserted into the insertion opening 232 along the axial direction X, so that the connecting structure 32 is connected with the guide part 2. The shape and size of the insertion opening 232 are matched with the shape and size of the insertion portion 321, and the insertion portion 321 can be in interference fit with the insertion opening 232, alternatively, the insertion portion 321 can also be in gap fit with the insertion opening 232, appropriate fixing glue can be dripped into the insertion opening 232 to increase the connection strength between them, and avoid the lead-out sleeve 3 from sliding along the axial direction X, and improve the stability.

As shown in FIG. 9, the shape and size of the mounting groove 211 are adapted to the positioning portion 322 of the connecting structure 32, for example, the positioning portion 322 has an arc-shaped plate structure, and the surface of the mounting groove 211 is also arc-shaped, and the radian is the same as that of the positioning portion 322, so that the positioning portion 322 can be mounted in the mounting groove 211 along the axial direction X, which ensures the verticality of the lead-out sleeve 3 relative to the guide part 2 and has a positioning function.

Referring to FIG. 9, two opposite side walls of the mounting groove 211 are also provided with a first positioning notch 212 and a second positioning notch 213 which are opposite to each other. The first positioning notch 212 and the second positioning notch 213 are symmetrically arranged. As shown in FIG. 1, the first positioning fin 323 and the second positioning fin 324 are respectively engaged in the first positioning notch 212 and the second positioning notch 213. For example, the first positioning fin 323 and the second positioning fin 324 are in an interference fit with the first positioning notch 212 and the second positioning notch 213 in the vertical direction Z, respectively. For another example, the first positioning fin 323 and the second positioning fin 324 are respectively provided with a protrusion, and the inner walls of the first positioning notch 212 and the second positioning notch 213 are respectively provided with a clamping groove, when the first positioning fin 323 and the second positioning fin 324 are respectively disposed in the first positioning notch 212 and the second positioning notch 213, the protrusions can be correspondingly clamped in the clamping grooves to realize the clamping of the positioning fins and the positioning notches. In this way, the two fins can be prevented from sliding in the axial direction X, and the stability of the connection between the lead-out sleeve 3 and the guide part 2 can be further improved. In addition, the first positioning fin 323, the second positioning fin 324 and the insertion portion 321 can provide a three-point positioning function to ensure the positioning accuracy, verticality and stability of the lead-out sleeve 3.

As shown in FIG. 5 and FIG. 6, the first positioning fin 323 is spaced from the first side wall 311 of the accommodating structure 31, and the second positioning fin 324 is spaced from the second side wall 312 of the accommodating structure 31. That is, there is a distance between the end faces of the two positioning fins close to the accommodating structure 31 and the end faces of the two side walls of the accommodating structure 31, respectively, so that an isolation groove structure is formed between the positioning fins and the accommodating structure 31. Through the above arrangement, when the first positioning fin 323 and the second positioning fin 324 are installed in the first positioning notch 212 and the second positioning notch 213, the end faces of the first side wall 311 and the second side wall 312 are not in contact with the first guide side wall 21 of the guide part 2. On the one hand, the first guide side wall 21 can be prevented from generating resistance to the pressing of the first side wall 311 and the second side wall 312, so that the pressing difficulty can be reduced; on the other hand, when the first side wall 311 and the second side wall 312 are pressed, the deformation of the first side wall 311 and the second side wall 312 will not affect the first positioning fin 323 and the second positioning fin 324, that is, the two positioning fins will not be deformed or loosened by the pressing force, thus ensuring the accuracy of the installation position and the stability of the installation of the lead-out sleeve 3.

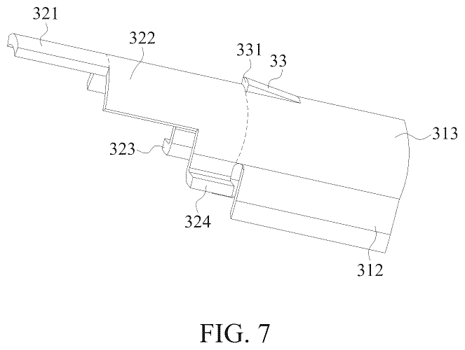

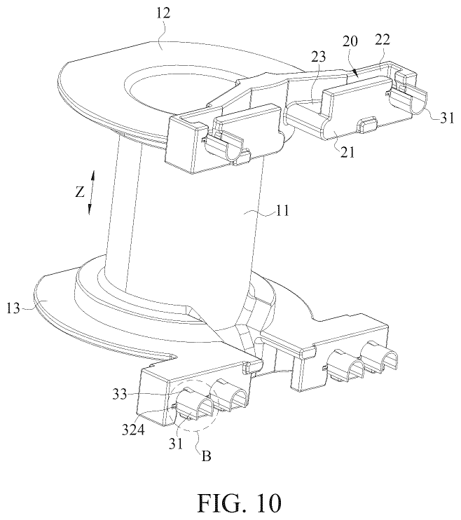

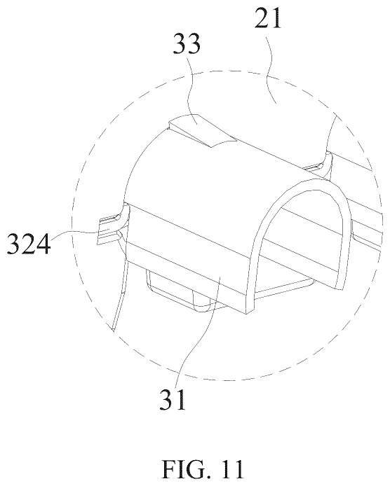

As shown in FIG. 7, in some embodiments, the lead-out sleeve 3 further includes a limiting structure 33, which is disposed on the accommodating structure 31 and is configured to extend in the direction close to the connecting structure 32, and the limiting structure 33 is provided with a limiting surface 331, as shown in FIG. 10 and FIG. 11, the limiting surface 331 is flush with the side surfaces of the first positioning fin 323 and the second positioning fin 324 and contacts the first guide side wall 21.

As shown in FIG. 7, in some embodiments, the limiting structure 33 may be a wedge-shaped projection, which can protrude from the outer surface of the arc-shaped bottom wall 313 of the accommodating structure 31 (the outer surface is the surface not used to warp the coil end 210) and extend close to the insertion portion 321 along the axial direction X, the limiting surface 331 is located at one end of the wedge-shaped projection near the insertion portion 321, and the limiting surface 331 is a vertical surface. When the lead-out sleeve 3 is installed on the guide part 2, the limiting surface 331 contacts with the first guide side wall 21, which provides a limiting function and a positioning function when the lead-out sleeve 3 is installed, so that the connecting structure 32 can be accurately installed in the guide part 2. Because the limiting surface 331 is flush with the side surfaces of the first positioning fin 323 and the second positioning fin 324, when the two positioning fins are installed in the two positioning notches, the positioning fins can be prevented from sliding along the axial direction X in the positioning notches, so that the two side walls of the accommodating structure 31 are prevented from contacting with the first guide side wall 21, the positioning accuracy is improved, and the installation difficulty is reduced, at the same time, the verticality of the lead-out sleeve 3 relative to the first guide side wall 21 is improved.

Of course, the limiting structure 33 can also be a projection of other shapes, such as a cuboid, a cube, a cylinder, etc., and the limiting surface 331 can be not only a plane, but also a curved surface, a bent surface, etc., as long as it can contact or abut against the surface of the first guide side wall 21 and realize the above functions when installing the lead-out sleeve 3, and there is no special limitation here. The limiting structure 33 can be formed by stamping from the bottom wall of the lead-out sleeve 3, which can simplify the process. The limiting structure 33 can also be a separate component, which is disposed on the arc-shaped bottom wall 313 by welding, bonding, etc., and is not particularly limited here.

In some embodiments, as shown in FIG. 5 to FIG. 7, the lead-out sleeve 3 can be integrally formed, the insertion portion 321 and the positioning portion 322 of the connecting structure 32 are both arc-shaped structures, such as arc-shaped plates, and are integrally formed with the arc-shaped bottom wall 313 of the accommodating structure 31, so that the manufacturing process can be simplified. Of course, it is not limited to this, the connecting structure 32 and the accommodating structure 31 of the lead-out sleeve 3 can also be non-integrally formed. For example, the connecting structure 32 and the accommodating structure 31 can be separate components and can be connected by welding, bonding or screwing, and there is no special limitation here. The insertion portion 321 and the positioning portion 322 can also be not the arc structures, for example, they can also be flat plate structures and structures with V-shaped cross section and inverted trapezoidal section, etc., there is no special limitation here, as long as they can be respectively adapted to the insertion opening 232 and the mounting groove 211 of the guide part 2, that is, the shapes of the insertion opening 232 and the mounting groove 211 can be adaptively designed according to the shapes of the insertion portion 321 and the positioning portion 322, and are not particularly limited here.

As shown in FIG. 5 to FIG. 7, when the insertion portion 321 and the positioning portion 322 are arc structures, the radian of the insertion portion 321 is matched with the radian of the positioning portion 322. In some embodiments, the radian of the insertion portion 321 is less than or equal to the radian of the positioning portion 322, so that the insertion portion 321 can pass through the mounting groove 211 of the first guide side wall 21 along the axial direction X and be smoothly inserted into the insertion opening 232 when the lead-out sleeve 3 is installed.

As shown in FIG. 1 and FIG. 2, the lead-out sleeve 3 is vertically connected with the side wall of the guide part 2. For example, the lead-out sleeve 3 is perpendicular to the vertical surface of the first guide side wall 21, so that after the coil end 210 is disposed in the lead-out sleeve 3, the lead-out sleeve 3 and the coil end 210 can be vertically inserted into the through hole of the PCB, ensuring smooth connection with the through hole.

In some embodiments, there is one guide part 2, and the guide part 2 has two guide channels 20, and each guide channel 20 is provided with at least one lead-out sleeve 3.

Take the guide part 2 located on the first flange portion 12 of the main body 1 as an example, the guide part 2 is provided with two guide channels 20, which extend in opposite directions, so as to avoid the crowding of the two ends of the coil 200 and further avoid short circuit. At the same time, the installation area provided by the main body 1 can be reasonably utilized, and the occupied space can be reduced. In other embodiments of the present disclosure, the guide part 2 may also be provided with more than two guide channels 20.

Each guide channel 20 can be provided with one, two, three or more lead-out sleeve(s), and the lead-out sleeve 3 which is most convenient for installing the coil end 210 can be selected.

As shown in FIG. 1 and FIG. 2, there are a plurality of guide parts 2, the plurality of guide parts 2 are disposed on the two opposite ends of the main body 1 in the vertical direction Z and each guide part 2 has at least one guide channel 20, and each guide channel 20 is provided with at least one lead-out sleeve 3.

The number of the guide parts 2 can be two, three, four or more. A plurality of guide parts 2 can be provided at the sides of the first flange portion 12 and the second flange portion 13 of the main body 1, and each guide part 2 can be provided with one, two, three or more guide channels 20. In this way, a plurality of coils 200 can be wound on one main body 1, and the two coil ends 210 of each coil 200 can be guided from the guide channel 20 into the lead-out sleeve 3. Each guide channel 20 can be provided with one, two, three or more lead-out sleeves 3.

In some embodiments, the guide part 2 can be integrally formed with the first flange portion 12 and/or the second flange portion 13 of the main body 1, for example, by an injection molding process.

As shown in FIG. 1, the main body 1 is provided with two guide parts 2, the first guide part 2a is provided on the first flange portion 12, and the second guide part 2b is provided on the second flange portion 13, and the first guide part 2a and the second guide part 2b respectively have two guide channels 20, each guide channel 20 of the first guide part 2a is provided with a lead-out sleeve 3, and each guide channel 20 of the second guide part 2b is provided with two lead-out sleeves 3. The number of the above-mentioned guide parts 2, the number of the guide channels 20 of each guide part 2 and the number of the lead-out sleeves 3 can be set by those skilled in the art according to actual needs, and there is no special limitation here.

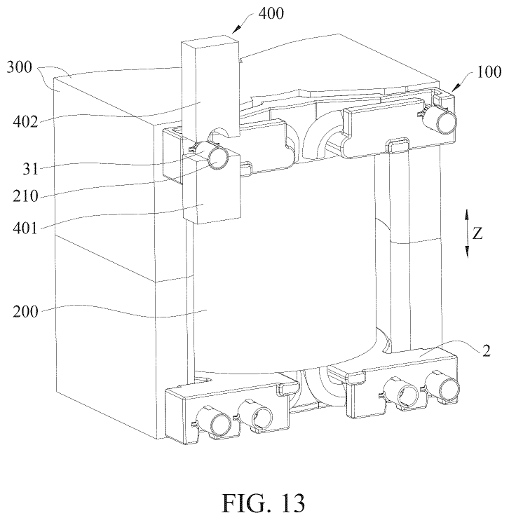

As shown in FIG. 13, the embodiments of the present disclosure also provide a magnetic element including a bobbin structure 100 and a coil 200. The bobbin structure 100 includes a main body 1, a guide part 2 and a lead-out sleeve 3. Where, the guide part 2 is disposed on the end of the main body 1 in the vertical direction Z, and the guide part 2 is provided with a guide channel 20. The lead-out sleeve 3 is disposed on the guide part 2 and communicates with the guide channel 20. The lead-out sleeve 3 includes an accommodating structure 31 with an opening, and the accommodating structure 31 protrudes from the guide part 2. The bobbin structure 100 can be the bobbin structure 100 described in any of the above embodiments, and other structures of the bobbin structure 100 will not be described here.

The coil 200 is wound on the main body 1, and the coil end 210 is guided by the guide channel 20 and located in the lead-out sleeve 3, the lead-out sleeve 3 is provided with a closed annular space S, and the coil end 210 is fixedly connected in the closed annular space S.

As shown in FIG. 13, the magnetic element can further include an iron core 300 provided on the main body 1. Specifically, the iron core 300 can have a frame structure, and the main body 1 is placed in the frame structure. After the coil 200 is energized, the iron core 300 can provide a magnetic circuit.

In some embodiments, there can be one, two, three or more coils 200, and each coil 200 has two coil ends 210, and the coil ends 210 may be wrapped in the lead-out sleeve 3 which is disposed on the bobbin structure 100.

In the magnetic element of the embodiments of the present disclosure, the coil end 210 can be guided into the lead-out sleeve 3 through the guide channel 20, so that the automatic wire arrangement can be realized, and the multi-stranded wires of the coil 200 can not be scattered. The coil end 210 with multi-stranded wires is accommodated in the annular space to form a pin with the accommodating structure 31, which can be directly connected with the through hole of the PCB, thus the outer surface of the accommodating structure 31 is electrically connected with the through hole of the PCB, and the inner surface of the accommodating structure 31 is electrically connected with the coil 200, so that the coil 200 is electrically connected with the through hole of the PCB, and the occupied space is reduced, the operation is simple and the connection between the pin formed by the coil end 210 and the accommodating structure 31 and the through hole is more accurate.

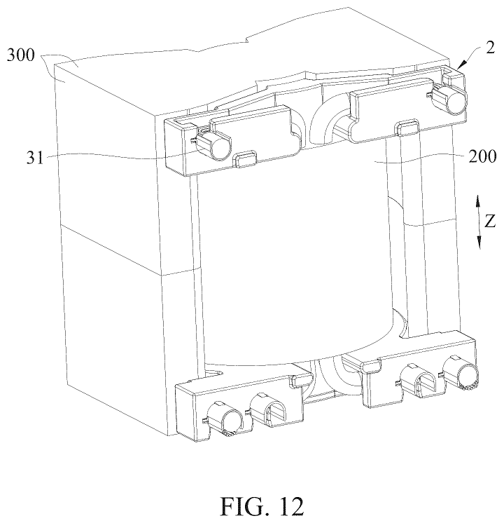

As shown in FIG. 12 and FIG. 13, the embodiments of the present disclosure also provide a method for leading out a coil, which includes the following contents A1 to A4.

A1: A bobbin structure 100 is provided. The bobbin structure 100 can be the same in any one of the above embodiments, and the detailed structure thereof will not be described here.

A2: The coil 200 is wound around the main body 1 of the bobbin structure 100, and the coil end 210 is guided through the guide channel 20 of the guide part 2 of the bobbin structure 100 into the lead-out sleeve 3.

A3: The lead-out sleeve 3 is pressed to form a closed annular space S, so as to wrap the coil end 210.

As shown in FIG. 13, a pressing tool 400 can be used to press the lead-out sleeve 3. The pressing tool 400 includes a first pressing block 401 and a second pressing block 402. The first pressing block 401 and the second pressing block 402 have a semicircular depression respectively, and the two semicircular depressions can be spliced into a complete circle. When the pressing is performed, the arc-shaped bottom wall 313 of the accommodating structure 31 is supported on the semicircular depression of the first pressing block 401, and the second pressing block 402 is placed and the semicircular depression thereof corresponds to the first side wall 311 and the second side wall 312 of the accommodating structure 31, a force is applied to the second pressing block 402 to press the first side wall 311 and the second side wall 312 in a direction close to the first pressing block 401, and the first side wall 311 and the second side wall 312 are deformed and finally a semicircular depression shape corresponding to the second pressing block 402 is formed, so that the first side wall 311, the second side wall 312 and the arc-shaped bottom wall 313 form a closed annular space S and are wrapped around the coil end 210.

The pressing tool 400 can be selected according to the diameter of the arc-shaped bottom wall 313 of the accommodating structure 31, so that the semicircular depressions of the first pressing block 401 and the second pressing block 402 can be adapted to the arc-shaped bottom wall 313.

A4: The coil end 210 is welded to the lead-out sleeve 3 to form a lead-out end.

When the coil end 210 is guided into the lead-out sleeve 3, the coil end 210 can be welded with the inner wall of the closed annular space S of the accommodating structure 31 to prevent the coil end 210 from slipping out, and at the same time, the coil 200 can be electrically connected with the lead-out sleeve 3, and the lead-out sleeve 3 can be electrically connected with the through hole after the pin formed by the coil end 210 and the lead-out sleeve 3 are welded in the through hole, so as to ensure that the coil 200 can be electrically connected with the circuit in the PCB through the through hole.

In some embodiments, the welding process such as wave soldering or reflow soldering can be used to weld the coil 200 and the lead-out sleeve 3.

In the embodiment of the present disclosure, after the coil end 210 is guided into the lead-out sleeve 3, or after the accommodating structure 31 of the lead-out sleeve 3 is pressed, or after the coil end 210 is welded with the lead-out sleeve 3, if the coil end 210 protrudes from the accommodating structure 31 along the axial direction X, the wire cutting operation can be performed, that is, the coil end 210 protruding from the accommodating structure 31 is subtracted, so that the end face of the coil 200 is flush with the end face of the accommodating structure 31, and the situation that the multi-stranded wires of the coil 200 are scattered and difficult to insert into the through hole is avoided.

To sum up, the method for leading out the coil of the embodiments of the present disclosure can guide the coil end 210 into the lead-out sleeve 3 through the guide channel 20, thereby realizing automatic wire arrangement and improving the lead-out efficiency, and the multi-stranded wires will not be scattered. After the coil 200 is guided into the lead-out sleeve 3, the accommodating structure 31 of the lead-out sleeve 3 is pressed to form a closed annular space S, so that the coil 200 is wrapped in the space, the coil 200 and the accommodating structure 31 form a pin, so that the pin has a more accurate size and can be connected with the through hole of the PCB more accurately, and the occupied space is reduced. The whole operation process is simple and fast, and the efficiency of leading out the coil is improved.

It should be noted that the specific structures such as “semicircular”, “circular” and “annular” mentioned in the present disclosure do not refer to semicircle, circle or ring structure in a strict sense, because the actual structure may produce certain deviation due to the needs of manufacturing technology or actual production, and the present disclosure is not limited to this.

It should be understood that the present disclosure is not limited to the detailed structure and arrangement of components set forth in this specification. The present disclosure is capable of other embodiments and of being realized and carried out in various ways. The foregoing variations and modifications are within the scope of the present disclosure. It should be understood that the present disclosure disclosed and defined in this specification extends to all alternative combinations of two or more individual features mentioned or obvious in the text and/or the drawings. All these different combinations constitute various alternative aspects of the present disclosure. The embodiments described in this specification illustrate the best ways known for carrying out the present disclosure and will enable those skilled in the art to adopt the present disclosure.

What is claimed is:

1. A bobbin structure, comprising:
a main body, used for winding a coil;
a guide part, disposed at an end portion of the main body in a vertical direction, wherein a guide channel is provided in the guide part; and
a lead-out sleeve, disposed on the guide part and configured to communicate with the guide channel, the lead-out sleeve comprising an accommodating structure with an opening, and the accommodating structure configured to protrude from the guide part;
wherein the guide channel is used to guide a coil end into the accommodating structure, the accommodating structure is malleable and configured to be able to close the opening after being pressed to form a closed annular space for wrapping the coil end.

2. The bobbin structure according to claim 1, wherein the lead-out sleeve further comprises a connecting structure, which is connected to the guide part;
the accommodating structure is connected with the connecting structure, the accommodating structure comprises a first side wall, a second side wall and an arc-shaped bottom wall, wherein the arc-shaped bottom wall is connected with the connecting structure, and the first side wall and the second side wall are located at opposite sides of the arc-shaped bottom wall, so that the accommodating structure is U-shaped; the first side wall and the second side wall are configured to form the closed annular space with the arc-shaped bottom wall after being pressed.

3. The bobbin structure according to claim 2, wherein a profile of a first section of the arc-shaped bottom wall is semicircular, a profile of a second section of the first side wall and the second side wall after being pressed is semicircular, so that a profile of a section of the accommodating structure after being pressed is circular.

4. The bobbin structure according to claim 2, wherein the guide part comprises:
a guide bottom wall;
a first guide side wall and a second guide side wall, which are located at opposite sides of the guide bottom wall and connected with the guide bottom wall to form the guide channel;
wherein the first guide side wall is provided with a mounting groove in the vertical direction, a mounting bottom surface of the mounting groove is lower than a surface of the guide bottom wall for carrying the coil end, so that a first side surface of the guide bottom wall facing the mounting groove is exposed; the first side surface is provided with an insertion opening extending in a direction close to the second guide side wall; two opposite side walls of the mounting groove are further provided with a first positioning notch and a second positioning notch which are opposite to each other.

5. The bobbin structure according to claim 4, wherein the connecting structure comprises:
an insertion portion, which is inserted into the insertion opening;
a positioning portion, which is cooperatively mounted in the mounting groove, one end of the positioning portion is connected with the insertion portion, and the other end is connected with the arc-shaped bottom wall of the accommodating structure; and
a first positioning fin and a second positioning fin, which are located at two opposite sides of the positioning portion and bent away from the positioning portion, the first positioning fin and the second positioning fin are respectively engaged in the first positioning notch and the second positioning notch, respectively.

6. The bobbin structure according to claim 5, wherein the first positioning fin is spaced from the first side wall, and the second positioning fin is spaced from the second side wall.

7. The bobbin structure according to claim 5, wherein the lead-out sleeve further comprises a limiting structure, which is disposed on the accommodating structure and is configured to extend in a direction close to the connecting structure, the limiting structure is provided with a limiting surface, and the limiting surface is flush with side surfaces of the first positioning fin and the second positioning fin and is configured to contact the first guide side wall.

8. The bobbin structure according to claim 5, wherein the lead-out sleeve is integrally formed, the insertion portion and the positioning portion of the connecting structure are both arc-shaped structures and are integrally formed with the arc-shaped bottom wall of the accommodating structure, a radian of the insertion portion is matched with a radian of the positioning portion.

9. The bobbin structure according to claim 1, wherein there is one guide part, and the guide part is provided with at least two guide channels, and each guide channel is provided with at least one lead-out sleeve.

10. The bobbin structure according to claim 1, wherein there are a plurality of guide parts, which are disposed on two opposite end portions of the main body in the vertical direction, and each guide part is provided with at least one guide channel, and each guide channel is provided with at least one lead-out sleeve.

11. The bobbin structure according to claim 1, wherein the lead-out sleeve is vertically connected with a side wall of the guide part.

12. The bobbin structure according to claim 2, wherein there is one guide part, and the guide part is provided with at least two guide channels, and each guide channel is provided with at least one lead-out sleeve.

13. The bobbin structure according to claim 2, wherein there are a plurality of guide parts, which are disposed on two opposite end portions of the main body in the vertical direction, and each guide part is provided with at least one guide channel, and each guide channel is provided with at least one lead-out sleeve.

14. The bobbin structure according to claim 2, wherein the lead-out sleeve is vertically connected with a side wall of the guide part.

15. A magnetic element, comprising:
a bobbin structure, comprising a main body, a guide part and a lead-out sleeve; wherein the guide part is disposed at an end portion of the main body in a vertical direction, a guide channel is provided in the guide part; the lead-out sleeve is disposed on the guide part and configured to communicate with the guide channel, the lead-out sleeve comprises an accommodating structure with an opening, and the accommodating structure is configured to protrude from the guide part;
a coil, wound on the main body, and a coil end is guided by the guide channel and located in the lead-out sleeve, the lead-out sleeve is provided with a closed annular space, and the coil end is fixedly connected in the closed annular space.

16. The magnetic element according to claim 15, wherein the lead-out sleeve further comprises a connecting structure, which is connected to the guide part;
the accommodating structure is connected with the connecting structure, the accommodating structure comprises a first side wall, a second side wall and an arc-shaped bottom wall, wherein the arc-shaped bottom wall is connected with the connecting structure, and the first side wall and the second side wall are located at opposite sides of the arc-shaped bottom wall, so that the accommodating structure is U-shaped; the first side wall and the second side wall are configured to form the closed annular space with the arc-shaped bottom wall after being pressed.

17. The magnetic element according to claim 16, wherein the guide part comprises:
a guide bottom wall;
a first guide side wall and a second guide side wall, which are located at opposite sides of the guide bottom wall and connected with the guide bottom wall to form the guide channel;
wherein the first guide side wall is provided with a mounting groove in the vertical direction, a mounting bottom surface of the mounting groove is lower than a surface of the guide bottom wall for carrying the coil end, so that a first side surface of the guide bottom wall facing the mounting groove is exposed; the first side surface is provided with an insertion opening extending in a direction close to the second guide side wall; two opposite side walls of the mounting groove are further provided with a first positioning notch and a second positioning notch which are opposite to each other.

18. The magnetic element according to claim 17, wherein the connecting structure comprises:
an insertion portion, which is inserted into the insertion opening;
a positioning portion, which is cooperatively mounted in the mounting groove, one end of the positioning portion is connected with the insertion portion, and the other end is connected with the arc-shaped bottom wall of the accommodating structure; and
a first positioning fin and a second positioning fin, which are located at two opposite sides of the positioning portion and bent away from the positioning portion, the first positioning fin and the second positioning fin are respectively engaged in the first positioning notch and the second positioning notch, respectively.

19. The magnetic element according to claim 18, wherein the first positioning fin is spaced from the first side wall, and the second positioning fin is spaced from the second side wall.

20. A method for leading out a coil, comprising:
providing a bobbin structure, the bobbin structure comprising a main body, a guide part and a lead-out sleeve; wherein the guide part is disposed at an end portion of the main body in a vertical direction, a guide channel is provided in the guide part; the lead-out sleeve is disposed on the guide part and configured to communicate with the guide channel, the lead-out sleeve comprises an accommodating structure with an opening, and the accommodating structure is configured to protrude from the guide part;
winding a coil around the main body of the bobbin structure, and guiding a coil end of the coil into the lead-out sleeve through the guide channel of the guide part of the bobbin structure;
pressing the lead-out sleeve to form a closed annular space to wrap the coil end;
welding the coil end to the lead-out sleeve to form a lead-out end.
